(19) United States
(12) Patent Application Publication
(10) Pub. No.: US 2025/0165091 A1
(43) Pub. Date: May 22, 2025

(54) SENSOR CONTROLLER AND STYLUS

(71) Applicant: Wacom Co., Ltd., Saitama (JP)

(72) Inventor: Haruhiko HISANO, Saitama (JP)

(21) Appl. No.: 18/933,838

(22) Filed: Oct. 31, 2024

(30) Foreign Application Priority Data
Nov. 16, 2023 (JP) 2023-194906

(51) Int. Cl. G06F 3/041; G06F 3/0354

(52) U.S. Cl. CPC G06F 3/04162; G06F 3/03545

(57) ABSTRACT

A position detection device is operated in a detection mode in which a multiprotocol simultaneous activation uplink signal is transmitted. The multiprotocol simultaneous activation uplink signal is obtained by adding, to a first portion configured to activate a stylus using a first protocol, subsequent data for activating the stylus using a second protocol different from the first protocol.

### BACKGROUND

### Technical Field

The present disclosure relates to a position detection device, a sensor controller, and a stylus. More particularly, the present disclosure relates to a stylus and a position detection device that prevents an old stylus supporting only an old protocol from being unusable by a new position detection device supporting a new protocol and a sensor controller included in the position detection device that bidirectionally communicates with the stylus.

### Description of the Related Art

A position detection device realizes pen input by detecting a position of a stylus in a touch surface. The position of the stylus is detected by bidirectional communication, via sensors arranged in the touch surface, between the stylus and a sensor controller included in the position detection device. Hereinafter, a signal transmitted from the sensor controller to the stylus will be referred to as an “uplink signal,” and a signal transmitted from the stylus to the sensor controller will be referred to as a “downlink signal.”

Japanese Patent No. 6603435 (hereinafter, referred to as Patent Document 1) discloses a technique capable of changing the time length of an uplink signal in a bidirectional communication system between a stylus and a sensor controller. In this technique, a length field (FIG. 3 of Patent Document 1) indicating the size of a command included in the uplink signal or a flag (FIG. 9 of Patent Document 1) indicating whether or not there is subsequent data in the uplink signal is arranged in order to recognize the uplink signal has variable time length.

Incidentally, a protocol that regulates the specific procedure of the bidirectional communication can change due to the emergence of a new technique. When the protocol changes, it is necessary to prevent an old stylus supporting only an old protocol from being unusable by a new position detection device supporting a new protocol.

### BRIEF SUMMARY

The present disclosure has been made in view of the above circumstances to provide a position detection device and a stylus that can prevent an old stylus supporting only an old protocol from being unusable by a new position detection device supporting a new protocol, and a sensor controller included in the position detection device to bidirectionally communicate with the stylus.

It is conceivable, as a specific technique for configuring a new position detection device so as to be usable with an old stylus, to alternately transmit an uplink signal according to a new protocol and an uplink signal according to an old protocol such that communication can be started using both the new protocol and the old protocol. However, in this case the transmission frequency of the uplink signal by each protocol becomes ½, and thus, the search efficiency of the stylus deteriorates.

Thus, another object of the present disclosure is to prevent a decrease in the search efficiency of the stylus while providing a position detection device and a stylus that can prevent an old stylus supporting only an old protocol from being unusable by a new position detection device supporting a new protocol.

In addition, where a new position detection device supporting a new protocol uses a stylus supporting a new protocol, bidirectional communication preferably can be started using the new protocol instead of the old protocol.

Thus, another object of the present disclosure is to provide a stylus that can start bidirectional communication by using a new protocol instead of an old protocol where a new position detection device supporting a new protocol uses a stylus supporting a new protocol.

According to a first aspect of the present disclosure, there is provided a position detection device that operates in a detection mode. Here, a multiprotocol simultaneous activation uplink signal is transmitted, which is obtained by adding, to a first portion configured to activate the stylus using a first protocol, subsequent data for activating the stylus using a second protocol different from the first protocol.

According to the first aspect of the present disclosure, there is also provided a stylus that includes a first determination section that determines whether or not a first uplink signal configured to activate the stylus by using a first protocol is included in a received signal. If the first determination section determines that the first uplink signal is included in the received signal, a second determination section determines whether or not first subsequent data for activating the stylus by using a second protocol different from the first protocol is added to the first uplink signal. There is also a transmission section that transmits a downlink signal by using the second protocol if the second determination section determines that the first subsequent data is added to the first uplink signal.

According to a second aspect of the present disclosure, there is provided a position detection device which, in a reservation time set in a frame indicated by a second uplink signal configured to activate a stylus by using a second protocol of a frame system, a first uplink signal is transmitted to activate the stylus by using a first protocol different from the second protocol.

According to a third aspect of the present disclosure, there is provided a stylus in which setting information indicates either a first protocol or a second protocol, where the first protocol and second protocol are different. When an uplink signal for activating the stylus through either the first protocol or the second protocol is received, a downlink signal is transmitted using the one indicated protocol read from the setting information. Further, when an uplink signal for activating the stylus through the other protocol that is not the one indicated protocol by the setting information is received, the downlink signal is not transmitted using the other protocol.

According to the first aspect of the present disclosure, not only the stylus supporting both the first protocol and the second protocol but also the stylus supporting only the first protocol can be activated by the multiprotocol simultaneous activation uplink signal transmitted by the position detection device supporting both the first protocol and the second protocol. Therefore, it is possible to prevent an old stylus supporting only the first protocol from being unusable by a new position detection device supporting the second protocol. In addition, since both the stylus supporting only the first protocol and the stylus supporting both the first protocol and the second protocol can be activated by one uplink signal, the multiprotocol simultaneous activation uplink signal, a decrease in the search efficiency of the stylus can also be prevented.

According to the second aspect of the present disclosure, since the first uplink signal is transmitted in the reservation time set in the frame indicated by the second uplink signal, it is possible to prevent the old stylus supporting only the first protocol from being unusable by the new position detection device supporting the second protocol while also preventing a decrease in the search efficiency of the stylus.

According to the third aspect of the present disclosure, since the protocol used for transmitting the downlink signal can be limited to one type, where the stylus supporting a new protocol is used by the new position detection device supporting the new protocol, bidirectional communication can be started using the new protocol instead of the old protocol.

### BRIEF DESCRIPTION OF THE SEVERAL VIEWS OF THE DRAWINGS

FIG. 1 is a diagram illustrating a configuration of a position detection system according to a first embodiment of the present disclosure;

FIG. 2 is a diagram illustrating an internal configuration of each of styluses 2₁ and 2₂ according to the first embodiment of the present disclosure;

FIG. 3 is a diagram illustrating a configuration example of a multiprotocol simultaneous activation uplink signal according to the first embodiment of the present disclosure;

FIG. 4 is a diagram illustrating an operation mode of a sensor controller and the styluses 2₁ and 2₂ and the transmission/reception timing of each signal (in the case where both of the styluses 2₁ and 2₂ are not present near a panel surface) according to the first embodiment of the present disclosure;

FIG. 5 is a diagram illustrating operation modes of the sensor controller and the styluses 2₁ and 2₂ and the transmission/reception timing of each signal (in the case where the stylus 2₁ approaches the panel surface) according to the first embodiment of the present disclosure;

FIG. 6 is a diagram illustrating operation modes of the sensor controller and the styluses 2₁ and 2₂ and the transmission/reception timing of each signal (in the case where the stylus 2₂ approaches the panel surface) according to the first embodiment of the present disclosure;

FIG. 7 is a diagram illustrating the operation modes of the sensor controller and the styluses 2₁ and 2₂ and the transmission/reception timing of each signal (in the case where the stylus 2₂ is separated from the panel surface) according to the first embodiment of the present disclosure;

FIG. 8 is a diagram illustrating the operation modes of an old-type sensor controller and the styluses 2₁ and 2₂ and the transmission/reception timing of each signal (in the case where the stylus 2₂ approaches the panel surface) according to the first embodiment of the present disclosure;

FIG. 9 is a diagram illustrating the operation modes of a sensor controller and styluses 2₁ and 2₂ and the transmission/reception timing of each signal (in the case where the stylus 2₂ approaches a panel surface) according to a first modified example of the first embodiment of the present disclosure;

FIG. 10 is a diagram illustrating the operation mode of a sensor controller and styluses 2₁ and 2₂ and the transmission/reception timing of each signal (in the case where both of the styluses 2₁ and 2₂ are not present near a panel surface) according to a second modified example of the first embodiment of the present disclosure; and

FIG. 11 is a diagram illustrating the operation mode of a sensor controller and styluses 2₁ and 2₂ and the transmission/reception timing of each signal (in the case where both of the stylus 2₁ and 2₂ are not present near a panel surface) according to a second embodiment of the present disclosure.

### DETAILED DESCRIPTION

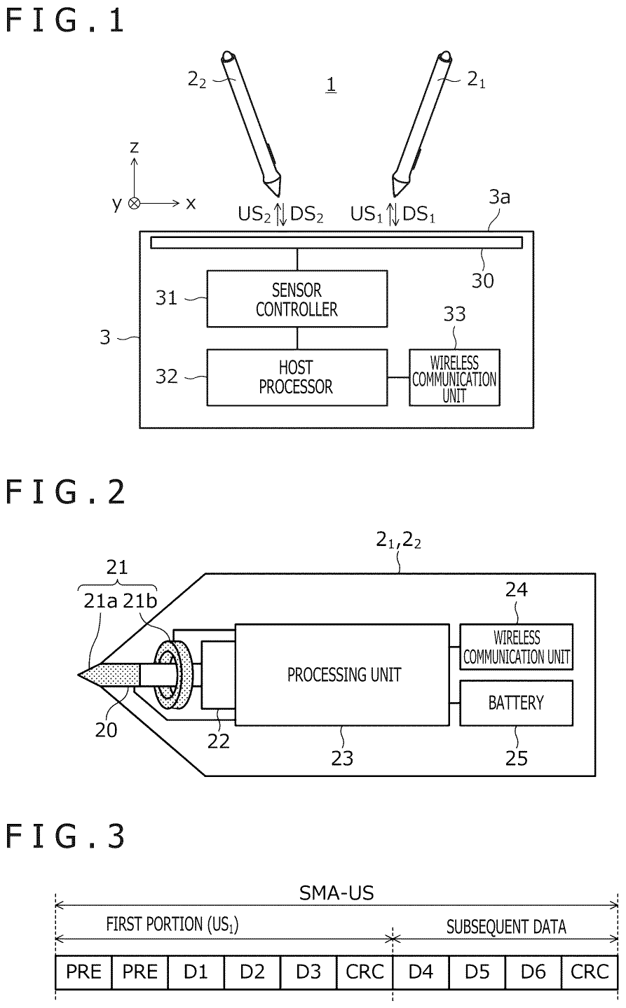

FIG. 1 is a diagram illustrating a configuration of a position detection system 1 according to the present embodiment. As depicted in the FIG. 1, the position detection system 1 has two types of styluses 2₁ and 2₂ and a position detection device 3. Among these, the position detection device 3 includes a panel surface 3a (touch surface), a sensor 30 arranged immediately below the panel surface 3a, a sensor controller 31, a host processor 32, and a wireless communication unit 33.

Each of the styluses 2₁ and 2₂ is a pen-type device capable of performing bidirectional communication with the sensor controller 31 via the sensor 30. In the following description, it is assumed that the bidirectional communication is performed by an active capacitance system, but the present disclosure is not limited to an active capacitance system and is also applicable to bidirectional communication performed by another system, such as an electromagnetic induction system.

The specific protocols used by the styluses 2₁ and 2₂ for the bidirectional communication are different. While the stylus 2₁ supports only a relatively old first protocol, the stylus 2₂ supports a relatively new second protocol and the first protocol. Hereinafter, in the case where it is not necessary to distinguish the styluses 2₁ and 2₂ from each other, the styluses 2₁ and 2₂ will collectively be referred to as a “stylus 2.”

The position detection device 3 is a computer that responds to input (pen input) by the stylus 2, and is, for example, a personal computer such as a smartphone, a tablet terminal, or a notebook personal computer. The panel surface 3a may also serve as a display surface of a display, and in this case, the display is arranged while overlapping the sensor 30.

The sensor 30 is a device used by the sensor controller 31 to perform the above-described bidirectional communication with the stylus 2 and has a sensor electrode group arranged in the panel surface 3a. Specifically, the sensor electrode group includes a plurality of X electrodes that each extend in a y-direction in the panel surface 3a and are juxtaposed at equal intervals in an x-direction and a plurality of Y electrodes that each extend in the x-direction in the panel surface 3a and are juxtaposed at equal intervals in the y-direction. The plurality of X electrodes and the plurality of Y electrodes are independently connected to the sensor controller 31. One of the plurality of X electrodes and the plurality of Y electrodes may also be used as common electrodes in the display, and the position detection device 3 in this case is called an “in-cell type.” Otherwise, the position detection device 3 is called an “on-cell type” or an “out-cell type” when the plurality of X electrodes and the plurality of Y electrodes are not used as common electrodes in the display. When a pen tip electrode 21 arranged at the pen tip of the stylus 2 approaches the sensor electrode group in the sensor 30, capacitive coupling occurs therebetween. In an active capacitance system, the bidirectional communication between the stylus 2 and the sensor controller 31 is executed via the capacitive coupling. Hereinafter, a signal transmitted from the sensor controller 31 to the stylus 2 via the capacitive coupling is referred to as an “uplink signal US,” and a signal transmitted from the stylus 2 to the sensor controller 31 via the capacitive coupling is referred to as a “downlink signal DS.”

The uplink signal US is a signal including a command from the sensor controller 31 to the stylus 2 and notifies the stylus 2 of the transmission timing of the downlink signal DS.

The downlink signal DS is a signal including a position signal that causes the sensor controller 31 to detect a position (hereinafter, referred to as a “pen position”) of the stylus 2 in the panel surface 3a and a data signal modulated by data (hereinafter, referred to as “pen data”) to be transmitted to the sensor controller 31. The pen data may include a pen pressure value, switch information indicating the on/off state of a switch provided on the surface of the stylus 2, identification information of the stylus 2, and other data, in addition to a response to the command in the uplink signal US.

Uplink signals US₁ and US₂ (first and second uplink signals, respectively) depicted in FIG. 1 represent the uplink signals US transmitted using the first protocol and the second protocol, respectively. Similarly, downlink signals DS₁ and DS₂ (first and second downlink signals, respectively) depicted in FIG. 1 represent the downlink signals DS transmitted using the first protocol and the second protocol, respectively. The uplink signal US transmitted by the sensor controller 31 includes, in addition to these signals, a multiprotocol simultaneous activation uplink signal SMA-US.

Here, in terms of the relation between the first protocol and the second protocol, typically, each protocol has different versions of the same communication standard (for example, an active capacitance system). For example, specific differences between the first protocol and the second protocol may appear in a reception timing of the downlink signal DS, a frequency of a carrier signal of the downlink signal DS, a modulation system of the data signal included in the downlink signal DS, a scheme of a spread code used to transmit the data signal included in the downlink signal DS, a format of the data signal included in the downlink signal DS, or a time slot used by the stylus 2 to transmit the downlink signal DS. It is possible differences also appear in the uplink signal US and the downlink signal DS. It should be noted that the first protocol and the second protocol may have different communication systems such as an active modulation system and an electromagnetic induction system.

In addition, in the present embodiment, the description continues on the assumption that the first protocol is a frameless-system protocol and that the second protocol is a frame-system protocol. However, this is only an example. The first protocol may be a frame-system protocol, and the second protocol may be a frameless-system protocol.

The frameless system is a system in which transmission of the downlink signal DS by the stylus 2 is performed immediately after the uplink signal US is received. The sensor controller 31 periodically transmits the uplink signal US, and the stylus 2 continuously performs a reception operation of the uplink signal US and immediately transmits the downlink signal DS when the uplink signal US is received.

On the other hand, the frame system is a system in which the sensor controller 31 sets a frame including a plurality of time slots. The sensor controller 31 transmits the uplink signal US at the beginning of the frame. In addition, the stylus 2 continuously performs a reception operation of the uplink signal US in the initial state and acquires the frame and a temporal position of each time slot set therein, according to a reception timing of the received uplink signal US. Then, the downlink signal DS is transmitted using each time slot. A time slot used by the stylus 2 to transmit the downlink signal DS may be designated by the sensor controller 31, and the stylus 2 in this case transmits the downlink signal DS by using the designated time slot. After receiving the uplink signal US once, the stylus 2 performs a reception operation of the uplink signal US only at the beginning of the frame.

The sensor controller 31 is an integrated circuit that carries out various types of functions by executing a program implemented as hardware or a program stored in a built-in memory. The functions of the sensor controller 31 include deriving the pen position and acquiring the pen data by executing the bidirectional communication with the stylus 2 and sequentially supplying reports including the derived pen position and the acquired pen data to the host processor 32.

In the present embodiment, the description continues on the assumption that the sensor controller 31 supports both the first protocol and the second protocol described above. The sensor controller 31 in this case is configured to be operable in a detection mode for detecting the stylus 2, a first communication mode for performing the bidirectional communication with the stylus 2 via the sensor 30 by using the first protocol, and a second communication mode for performing the bidirectional communication with the stylus 2 via the sensor 30 by using the second protocol. Hereinafter, in the case where it is not necessary to particularly distinguish the first communication mode and the second communication mode from each other, these will collectively be referred to as a “communication mode.”

In detection mode, the sensor controller 31 is configured to transmit the multiprotocol simultaneous activation uplink signal SMA-US at the beginning of the frame set according to the second protocol. Further, on the basis of the reception status of the downlink signal DS, the sensor controller 31 is configured to enter either the first communication mode or the second communication mode and execute the bidirectional communication with the stylus 2 according to the entered communication mode. Hereinafter, the entry of the sensor controller 31 into either of the communication modes will be referred to as “pairing with the stylus 2.”

The sensor controller 31 is also configured to derive the position of a finger on the panel surface 3a. This derivation is executed by, for example, a capacitance system. In this case, the sensor controller 31 supplies a finger detection signal, including pulses corresponding to the number of X electrodes, to each of the plurality of X electrodes in the sensor 30 and receives the signal at each of the plurality of Y electrodes in the sensor 30. Then, the correlation between the signal received at each Y electrode and the finger detection signal supplied to each X electrode is calculated, and the position of the finger is derived from a result of the calculation. The sensor controller 31 is configured to transmit and receive the finger detection signal at intervals of communication with the stylus 2 and sequentially supply reports including the position of the finger derived as a result thereof to the host processor 32.

The host processor 32 is a central processing unit of the position detection device 3 and is configured to execute an operating system of the position detection device 3 and various types of applications including a drawing application by executing a program stored in a built-in memory. A process performed by the operating system or drawing application uses a series of reports supplied from the sensor controller 31 to the host processor 32. These processes include generation and display of digital ink, movement of the cursor, detection of various gestures such as tapping and dragging, and other processes.

The wireless communication unit 33 is a device for communicating with another device including the stylus 2 by short-range wireless communication such as Bluetooth (registered trademark). The host processor 32 and the sensor controller 31 are configured to communicate with the stylus 2 by short-range wireless communication via the wireless communication unit 33.

FIG. 2 is a diagram illustrating an internal configuration of the stylus 2 (styluses 2₁ and 2₂). As depicted in FIG. 2, the stylus 2 has a core body 20, the pen tip electrode 21, a pressure sensor 22, a processing unit 23, a wireless communication unit 24, and a battery 25. In addition to these, the stylus 2 has a switch provided on the surface, a memory for storing identification information of the stylus 2, and the like whose illustrations are omitted in FIG. 2.

The core body 20 is a rod-shaped member constituting the pen tip of the stylus 2. The pen tip electrode 21 is an electrode provided at the pen tip of the stylus 2 that includes a pen chip 21a, rod-shaped electrode provided at the tip end of the core body 20, and a pen ring 21b, a ring-shaped electrode provided in such a manner as to surround the core body 20. The stylus 2 is configured to receive the uplink signal US by using one of or both the pen chip 21a and the pen ring 21b and to transmit the downlink signal DS from each of the pen chip 21a and the pen ring 21b. While the sensor controller 31 derives a position from the downlink signal DS transmitted from the pen chip 21a and the downlink signal DS transmitted from the pen ring 21b and acquires the pen position derived from the downlink signal DS transmitted from the pen chip 21a, the sensor controller 31 performs a process of calculating the tilt (tilt angle) of the stylus 2 on the basis of the two derived positions.

The pressure sensor 22 is a sensor that detects a pressure applied to the pen tip of the stylus 2 by detecting a force transmitted through the core body 20. The value of the pressure detected by the pressure sensor 22 is supplied to the processing unit 23 as a pen pressure value.

The processing unit 23 is a central processing unit of the stylus 2 and generates the downlink signal DS upon receival of the uplink signal US from the sensor controller 31 via the pen tip electrode 21 and transmits the generated downlink signal DS to the sensor controller 31 via the pen tip electrode 21. The content of the downlink signal DS generated by the processing unit 23 is as described above. The sensor controller 31 receives the position signal in the downlink signal DS at each of the plurality of X electrodes and the plurality of Y electrodes configuring the sensor 30, approximates the distribution of the reception intensity of the position signal in each of the x-direction and the y-direction by a normal distribution curve, and derives the respective peak positions to derive the pen position. In addition, the sensor controller 31 receives the data signal in the downlink signal DS at one X electrode or one Y electrode closest to the most recently derived pen position and demodulates the received data signal to acquire the pen data transmitted by the stylus 2.

The processing unit 23 is configured to be operable in a detection mode to detect the sensor controller 31 and a first communication mode for performing the bidirectional communication with the sensor controller 31 via the sensor 30 by using the first protocol. Further, the processing unit 23 of the stylus 2₂ is configured to be operable also in a second communication mode for performing the bidirectional communication with the sensor controller 31 via the sensor 30 by using the second protocol. The first communication mode and the second communication mode may also collectively be referred to as a “communication mode” when it is not necessary to distinguish them from each other.

The processing unit 23 having entered the detection mode performs continuously or intermittently a reception operation of the uplink signal US. When the uplink signal US is received by the reception operation, the processing unit 23 enters the communication mode and starts the bidirectional communication with the sensor controller 31. As described above, the uplink signal US has a role of shifting the operation mode of the stylus 2 from the detection mode to the communication mode. Hereinafter, the entry of the stylus 2 into either of the communication modes will be referred to as “pairing with the position detection device 3 (or the sensor controller 31),” and the shift of the stylus 2 from the detection mode to the communication mode will be referred to as “activation.” In addition, the shift of the stylus 2 from the detection mode to the first communication mode will be referred to as “activation using the first protocol,” and the shift from the detection mode to the second communication mode will be referred to as “activation using the second protocol.” The uplink signal US₁ transmitted using the first protocol activates the stylus 2 by using the first protocol. Similarly, the uplink signal US₂ transmitted using the second protocol has a role of activating the stylus 2 by using the second protocol.

The wireless communication unit 24 is a device for communicating with another device including the position detection device 3 by short-range wireless communication such as Bluetooth (registered trademark). The processing unit 23 is configured to be capable of communicating with the host processor 32 and the sensor controller 31 in the position detection device 3 via the wireless communication unit 33 by short-range wireless communication.

The battery 25 is a power supply device for supplying operation electric power to each unit of the stylus 2 by which the processing unit 23 and the wireless communication unit 24 are configured to operate by.

FIG. 3 is a diagram illustrating a configuration example of the multiprotocol simultaneous activation uplink signal SMA-US. As depicted in FIG. 3, the multiprotocol simultaneous activation uplink signal SMA-US according to this example includes 10 symbols (units of information transmitted using one spread code). The top two symbols “PRE” are preamble data that cause the stylus 2 to detect that the received signal is the uplink signal US. Three symbols “D1,” “D2,” and “D3” following the two symbols “PRE” represent commands for the stylus 2.

The symbol “CRC” following the symbol “D3” is a cyclic code generated on the basis of the symbols “D1,” “D2,” and “D3,” and causes the stylus 2 to detect a reception error of the symbols “D1,” “D2,” and “D3.” Three symbols “D4,” “D5,” and “D6” following the symbol “CRC” represent commands for the stylus 2 as with the symbols “D1,” “D2,” and “D3.” The symbol “CRC” following the symbol “D6” is a cyclic code generated on the basis of the symbols “D4,” “D5,” and “D6,” and causes the stylus 2 to detect a reception error of the symbols “D4,” “D5,” and “D6.”

A portion from the top symbol “PRE” to the first symbol “CRC” is a first portion configured to activate the stylus 2 by using the first protocol and has a configuration similar to that of the uplink signal US₁. A portion from the symbol “D4” to the second symbol “CRC” configures subsequent data for activating the stylus 2 through the second protocol. The configuration of the subsequent data is obtained by excluding the preamble data from the uplink signal US₂.

The processing unit 23 of the stylus 2₁ that does not support the second protocol is configured to determine whether or not the received signal supplied from the pen tip electrode 21 includes the uplink signal US₁, and to enter the first communication mode if it is determined to include the uplink signal US₁. Therefore, if the multiprotocol simultaneous activation uplink signal SMA-US is received, the processing unit 23 of the stylus 2₁ determines that the uplink signal US₁ has been received, only from the first portion thereof, and enters the first communication mode. The processing unit 23 having entered the first communication mode performs a process of generating the downlink signal DS₁ based on receival of the uplink signal US₁ and transmitting the generated downlink signal DS₁. Subsequently, the processing unit 23 performs a reception operation (specifically, an operation of determining whether or not the uplink signal US₁ is included in the received signal supplied from the pen tip electrode 21) of the uplink signal US again, and generates the downlink signal DS₁ on the basis of the uplink signal US₁ received as a result thereof and transmits the generated downlink signal DS₁. Thereafter, the processing unit 23 repeatedly executes the similar process until the uplink signal US₁ is no longer received. If the state where the uplink signal US₁ is not received is continued for a predetermined period of time, the processing unit 23 of the stylus 2₁ returns to the detection mode.

On the other hand, the processing unit 23 of the stylus 2₂ that supports both the first protocol and the second protocol determines whether or not the first portion (the uplink signal US₁) of the multiprotocol simultaneous activation uplink signal SMA-US is included in the received signal supplied from the pen tip electrode 21. If it is determined to be included, the second protocol further determines whether or not the above-described subsequent data is added to the detected first portion. If it is determined that the subsequent data is added, the processing unit 23 is configured to enter the second communication mode.

Here, since the second protocol is a frame-system protocol, the processing unit 23 of the stylus 2₂ acquires the frame and the temporal position of each time slot set therein, based upon the reception timing of the multiprotocol simultaneous activation uplink signal SMA-US, and transmits the downlink signal DS₂ by using each time slot. Subsequently, the processing unit 23 performs a reception operation of the uplink signal US₂ at the beginning of the next frame and performs a process similar to the above where the uplink signal US₂ has been received. Thereafter, the processing unit 23 repeatedly executes the similar process until the uplink signal US₂ is no longer received. If a state in which the uplink signal US₂ is not received is continued for a predetermined period of time, the processing unit 23 of the stylus 2₂ returns to the detection mode.

In the determination as to whether or not the subsequent data is added to the detected first portion, where it is determined that no subsequent data is added (that is, in the case where the received uplink signal US is not the multiprotocol simultaneous activation uplink signal SMA-US but only the uplink signal US₁), the processing unit 23 of the stylus 2₂ enters the first communication mode. In this case, the process executed by the processing unit 23 is similar to the process described for the processing unit 23 of the stylus 2₁. As described above, the processing unit 23 of the stylus 2₂ enters the first communication mode in the case where the sensor controller 31 does not support the second protocol.

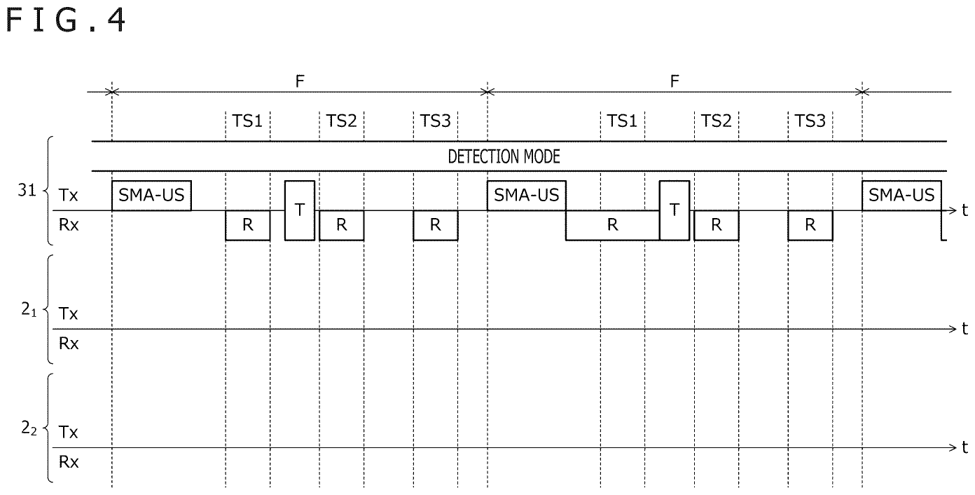

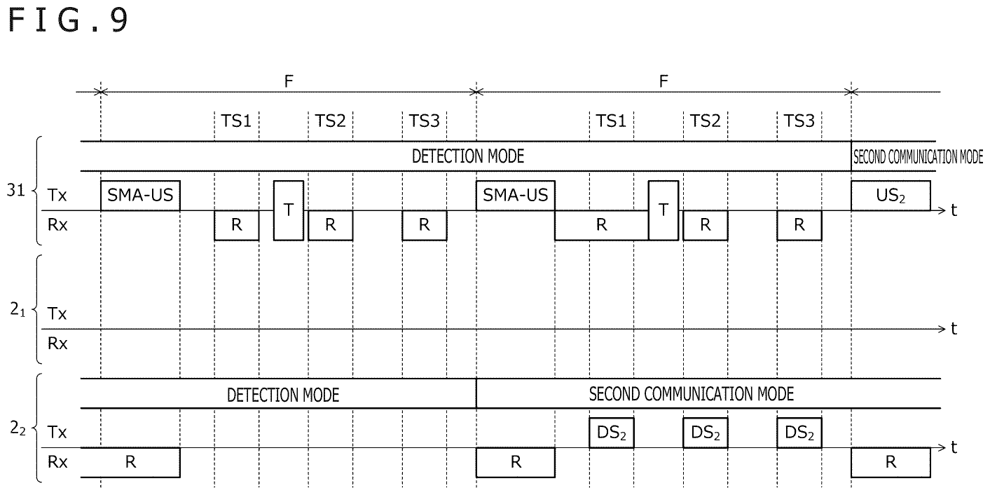

FIG. 4 to FIG. 8 are each a diagram illustrating the operation modes of the sensor controller 31 and the styluses 2₁ and 2₂ and the transmission/reception timing of each signal. It should be noted that a frame F depicted in these drawings and subsequent FIG. 9 to FIG. 11 is a frame set by the sensor controller 31 according to the second protocol, and time slots TS1, TS2, and TS3 are time slots set in the frame F. In the present embodiment, the three time slots TS1, TS2, and TS3 are set in one frame F for simplicity, but more time slots are set in practice.

FIG. 4 illustrates a case where both styluses 2₁ and 2₂ are not present near the panel surface 3a. The sensor controller 31 in the case of the drawing is not paired with any of the styluses 2₁ and 2₂ and has entered the detection mode. The sensor controller 31 in this case transmits the multiprotocol simultaneous activation uplink signal SMA-US at the beginning of each frame F. In addition, after the transmission of the multiprotocol simultaneous activation uplink signal SMA-US is completed, the sensor controller 31 executes a reception operation R of the downlink signal DS and a transmission/reception operation T of the above-described finger detection signal in the same frame F. As depicted in FIG. 4, the reception operation R is executed in each time slot, and the transmission/reception operation T is executed at intervals of the reception operation R.

Upon the reception operation R receiving the signal, the sensor controller 31 having entered the detection mode determines whether the signal is the downlink signal DS₁ or DS₂. This determination may be made, for example, by checking the difference (the frequency of the carrier signal of the downlink signal DS or the like) between the first protocol and the second protocol described above. In the example of FIG. 4, the signal received in the time slot TS1 may be determined to be the downlink signal DS₁, and the signals received in the time slots TS2 and TS3 may be determined to be the downlink signal DS₂. In addition, in the case where the data obtained by demodulating the received signal includes information regarding the protocol used by the stylus 2 to transmit the downlink signal DS, the sensor controller 31 may determine whether the received signal is the downlink signal DS₁ or DS₂. The sensor controller 31 repeats the above operation in each frame F until either of the downlink signals DS₁ and DS₂ is received.

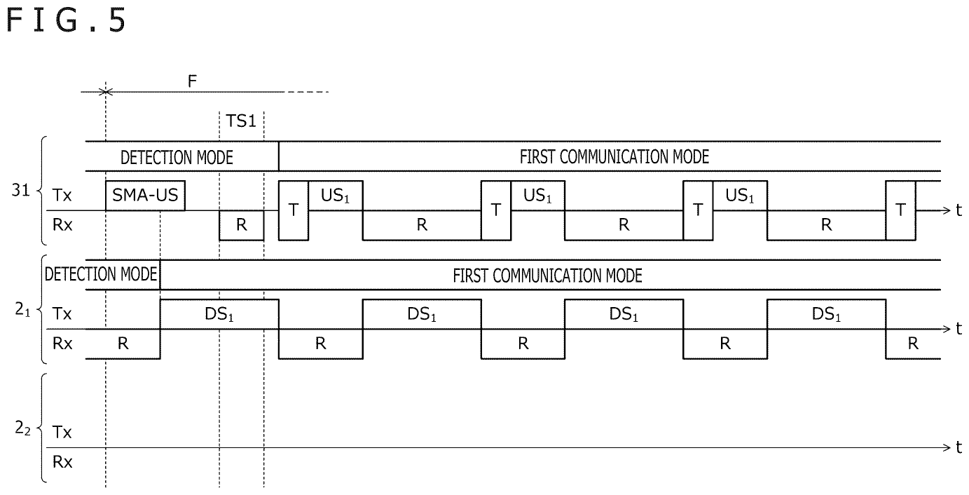

FIG. 5 illustrates a case where the stylus 2₁ approaches the panel surface 3a. The stylus 2₁ having entered the detection mode continuously executes the reception operation R of the uplink signal US and determines whether or not the uplink signal US₁ is included in the signal received as a result thereof. As in the example depicted in FIG. 5, if the received signal is the multiprotocol simultaneous activation uplink signal SMA-US, the stylus 2₁ determines that the uplink signal US₁ is included. The stylus 2₁ having determined that the uplink signal US₁ is included enters the first communication mode and transmits the downlink signal DS₁. While the transmission of the downlink signal DS₁ continues across the time slot TS1 as depicted in FIG. 5, the stylus 2₂ is configured not to transmit the downlink signal DS₂ in the time slot TS1 immediately after the reception of the multiprotocol simultaneous activation uplink signal SMA-US. Therefore, when the downlink signal DS is received through the reception operation R performed in the time slot TS1, the sensor controller 31 can determine that it is the downlink signal DS₁. The sensor controller 31, having determined that the downlink signal DS₁ has been received, shifts to the first communication mode, and thereafter executes the transmission of the uplink signal US₁. The reception operation R is in a predetermined cycle while interposing the transmission/reception operation T of the finger detection signal. Accordingly, the bidirectional communication using the first protocol is realized between the sensor controller 31 and the stylus 2₁.

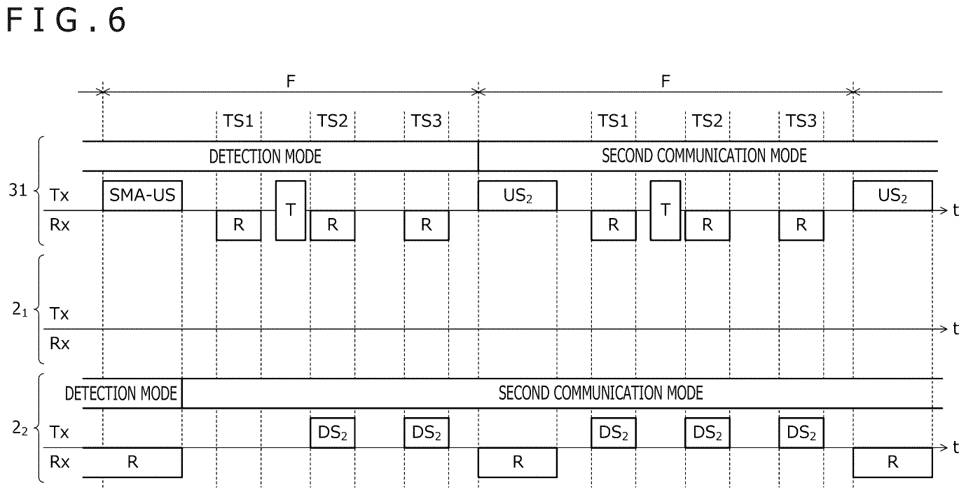

FIG. 6 illustrates a case where the stylus 2₂ approaches the panel surface 3a. The stylus 2₂ having entered the detection mode continuously executes the reception operation R of the uplink signal US as with the stylus 2₁ and determines whether or not the uplink signal US₁ is included in the signal received as a result thereof (first determination section). As in FIG. 6, if the received signal is the multiprotocol simultaneous activation uplink signal SMA-US, the stylus 2₂ determines that the uplink signal US₁ is included. Next, the stylus 2₂, having determined that the uplink signal US₁ is included, determines whether or not the subsequent data (first subsequent data) for activating the stylus 2 by using the second protocol is added to the uplink signal US₁ (second determination section). If the received signal is the multiprotocol simultaneous activation uplink signal SMA-US, the stylus 2₂ determines that the subsequent data is added. The stylus 2₂ having determined that the subsequent data is added enters the second communication mode, and acquires the frame F and the temporal position of each of the time slots TS1, TS2, and TS3 set therein, based upon the reception timing of the multiprotocol simultaneous activation uplink signal SMA-US. Then, as described above, the transmission of the downlink signal DS₂ is executed in the time slots TS2 and TS3 excluding the time slot TS1 (transmission section).

When receiving the downlink signal DS₂ in the reception operation R performed in the time slots TS2 and TS3, the sensor controller 31 shifts to the second communication mode from the next frame F, and thereafter performs an operation according to the second protocol. Specifically, the uplink signal US₂ is transmitted at the beginning of each frame F, and the reception operation R is executed in each of the time slots TS1, TS2, and TS3 while the transmission/reception operation T of the finger detection signal is interposed by using the time between the time slots TS1, TS2, and TS3. Accordingly, the bidirectional communication using the second protocol is realized between the sensor controller 31 and the stylus 2₂.

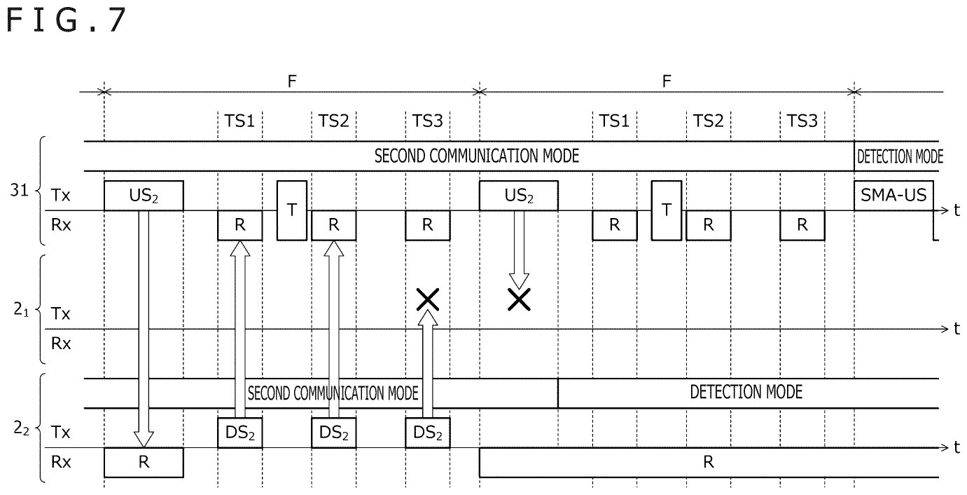

FIG. 7 illustrates a case where the stylus 2₂ communicating with the sensor controller 31 in the example of FIG. 6 is separated from the panel surface 3a after the time slot TS3 of the first frame F and where the transmission/reception of the uplink signal US₂ and the downlink signal DS₂ cannot be performed.

The stylus 2₂ selects whether to continue the pairing with the position detection device 3 in each frame F during the communication in the second communication mode (pairing state selection section). Specifically, in the case where the uplink signal US₂ is received at the beginning of each frame F, continuation of the pairing with the position detection device 3 is selected, while, in the case where the uplink signal US₂ is not received, cancellation of the pairing with the position detection device 3 is selected. In the example of FIG. 7, in response to the fact that the uplink signal US₂ is not received at the beginning of the second frame F, the stylus 2₂ selects cancellation of the pairing with the position detection device 3. It should be noted that, in the case where the uplink signal US₂ is not continuously received over two or more frames F, the stylus 2₂ may select cancellation of the pairing with the position detection device 3.

The stylus 2₂ having selected the cancellation of the pairing with the position detection device 3 cancels the pairing with the position detection device 3 by returning to the detection mode from the second communication mode. Since the stylus 2₂ that has returned to the detection mode no longer transmits the downlink signal DS₂, the sensor controller 31 cannot receive the downlink signal DS₂ in each of the time slots TS1, TS2, and TS3. The sensor controller 31 also performs the process similar to that of the stylus 2₂ in each frame F, cancels the pairing with the stylus 2₂ in response to the fact that the downlink signal DS₂ is not received, and returns to the detection mode. The process performed after both return to the detection mode is as described above with reference to FIG. 6.

Here, although the cancellation of the pairing in the second protocol has been described in FIG. 7, the same applies to the first protocol. In addition, although an example in which the cancellation of the pairing is performed on the basis of the reception states of the uplink signal US and the downlink signal DS has been described in FIG. 7, the stylus 2 and the sensor controller 31 may agree on the cancellation of the pairing by short-range wireless communication using the wireless communication units 24 and 33, and both may return to the detection mode on the basis of a result thereof.

As described above, according to the position detection system 1 of the present embodiment, not only the stylus 2₂ supporting both the first protocol and the second protocol but also the stylus 2₁ supporting only the first protocol can be activated by the multiprotocol simultaneous activation uplink signal SMA-US transmitted by the position detection device 3 supporting both the first protocol and the second protocol, and thus, it is possible to prevent the old stylus 2₁ supporting only the first protocol from being unusable by the new position detection device 3 supporting the second protocol. In addition, since both of the styluses 2₁ and 2₂ can be activated by one uplink signal, the multiprotocol simultaneous activation uplink signal SMA-US, a decrease in the search efficiency of the stylus 2 is prevented as compared with a case where the uplink signals US₁ and US₂ are alternately transmitted at the beginning of each frame F.

Here, a process in the case where the stylus 2₂ approaches the panel surface 3a of the position detection device 3 (hereinafter, this position detection device 3 will be referred to as an “old-type position detection device 3,” and the sensor controller 31 provided in the old-type position detection device 3 will be referred to as an “old-type sensor controller 31”) that supports only the first protocol and does not support the second protocol will be described.

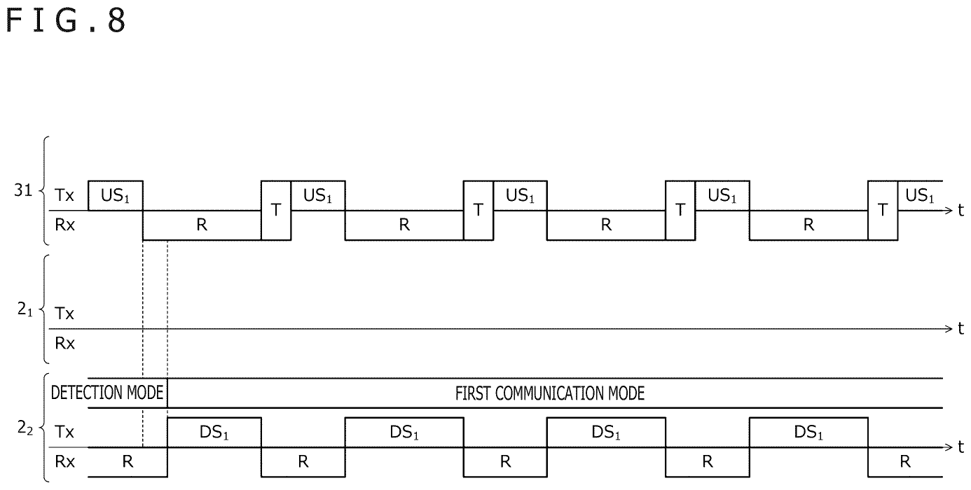

FIG. 8 is a diagram illustrating the operation modes of the old-type sensor controller 31 and the styluses 2₁ and 2₂ and the transmission/reception timing of each signal. FIG. 8. depicts a case where the stylus 2₂ approaches the panel surface 3a of the old-type position detection device 3. As depicted, the old-type sensor controller 31 is configured to repeatedly execute the transmission of the uplink signal US₁, the reception operation R of the downlink signal DS, and the transmission/reception operation T of the finger detection signal. The old-type sensor controller 31 does not transmit the multiprotocol simultaneous activation uplink signal SMA-US.

As described with reference to FIG. 6, the stylus 2₂ that has entered the detection mode continuously executes the reception operation R of the uplink signal US, and determines whether or not the uplink signal US₁ is included in the signal received as a result thereof. In the case of determining that the uplink signal US₁ is included, the stylus 2₂ further determines whether or not the subsequent data for activating the stylus 2 by using the second protocol is added to the uplink signal US₁. In the case of FIG. 8, since there is no subsequent data, the stylus 2₂ determines there is no subsequent data and enters the first communication mode. The stylus 2₂ that has the first communication mode immediately transmits the downlink signal DS₁. The subsequent process is similar to that of the stylus 2₁ described with reference to FIG. 5. As described above, in the case where the stylus 2₂ approaches the panel surface 3a of the old-type position detection device 3, the stylus 2₂ starts communication with the old-type sensor controller 31 in the first communication mode.

FIG. 9 is a diagram illustrating the operation modes of the sensor controller 31 and the stylus 2₁ and 2₂ and the transmission/reception timing of each signal according to a first modified example of the first embodiment of the present disclosure. As in FIG. 6, the drawing depicts a case where the stylus 2₂ approaches the panel surface 3a.

The present modified example is different from the first embodiment in that the stylus 2₂, having received the multiprotocol simultaneous activation uplink signal SMA-US when entering the detection mode, starts the entry into the second communication mode and the transmission of the downlink signal DS₂ not in a frame F where the multiprotocol simultaneous activation uplink signal SMA-US is received but in a subsequent frame F (typically, the next frame F). As described above, only the reception of the multiprotocol simultaneous activation uplink signal SMA-US may be performed in the first frame F, and the communication may be started from the next frame F.

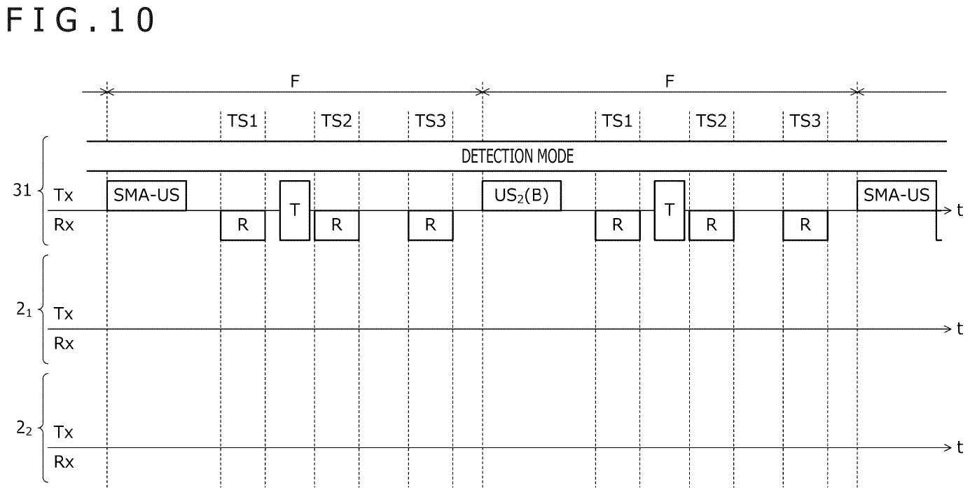

FIG. 10 is a diagram illustrating the operation modes of the sensor controller 31 and the stylus 2₁ and 2₂ and the transmission/reception timing of each signal according to a second modified example of the first embodiment of the present disclosure. As in FIG. 4, the drawing depicts a case where both styluses 2₁ and 2₂ are not present near the panel surface 3a.

The present modified example is different from the first embodiment in that two types of uplink signals US₂ are used. The first type of uplink signal US₂ is the same as that used in the present embodiment and is transmitted as a part of the multiprotocol simultaneous activation uplink signal SMA-US if the sensor controller 31 has entered the detection mode. The second type of uplink signal US₂ is a signal whose settings are different from those of the first type of uplink signal US₂. Examples of such settings include the code length of the spread code, the code structure of the spread code, and the frequency of the carrier signal.

Hereinafter, the setting of the first type of uplink signal US₂ will be referred to as a setting A while the setting of the second type of uplink signal US₂ will be referred to as a setting B. Assuming that the uplink signal US₂ transmitted with the setting A is an uplink signal US₂ (A) while the uplink signal US₂ transmitted with the setting B is an uplink signal US₂ (B), the sensor controller 31 is configured to transmit the multiprotocol simultaneous activation uplink signal SMA-US including the transmission of the uplink signal US₂ (A) and transmit the uplink signal US₂ (B) according to a predetermined schedule as depicted in FIG. 10. For example, the predetermined schedule may be such that the multiprotocol simultaneous activation uplink signal SMA-US and the uplink signal US₂ (B) are alternately transmitted in units of frames F.

The stylus 2₂ supporting the second protocol is configured to alternately or simultaneously wait for the multiprotocol simultaneous activation uplink signal SMA-US and the uplink signal US₂ (B) and perform the transmission of the subsequent downlink signal DS₂ by using the settings (the spread code, frequency, and the like) of the received signal. The sensor controller 31 waits for the downlink signal DS₂ transmitted with the setting A in the frame F transmitting the multiprotocol simultaneous activation uplink signal SMA-US and for the downlink signal DS₂ transmitted with the setting B in the frame F transmitting the uplink signal US₂ (B). As a result, if the downlink signal DS₂ is received in the frame transmitting the multiprotocol simultaneous activation uplink signal SMA-US, the sensor controller 31 performs the subsequent communication with the setting A. If the downlink signal DS₂ is received in the frame transmitting the uplink signal US₂ (B), the sensor controller 31 performs the subsequent communication with the setting B. In this way, even if communication with one setting becomes difficult due to, for example, occurrence of strong external noise, the possibility of continuing the communication with the other setting increases.

Next, the position detection system 1 according to the present embodiment is different from the position detection system 1 according to the first embodiment in that the position detection system 1 according to the present embodiment executes the transmission of the uplink signal US₂ at the beginning of each frame F instead of the transmission of the multiprotocol simultaneous activation uplink signal SMA-US or the execution of the transmission of the uplink signal US₁ at reservation time set in each frame F. Since the other features are similar to those of the position detection system 1 according to the first embodiment, the following description will be made focusing on differences between the position detection system 1 according to the first embodiment and position detection system 1 according to the present embodiment.

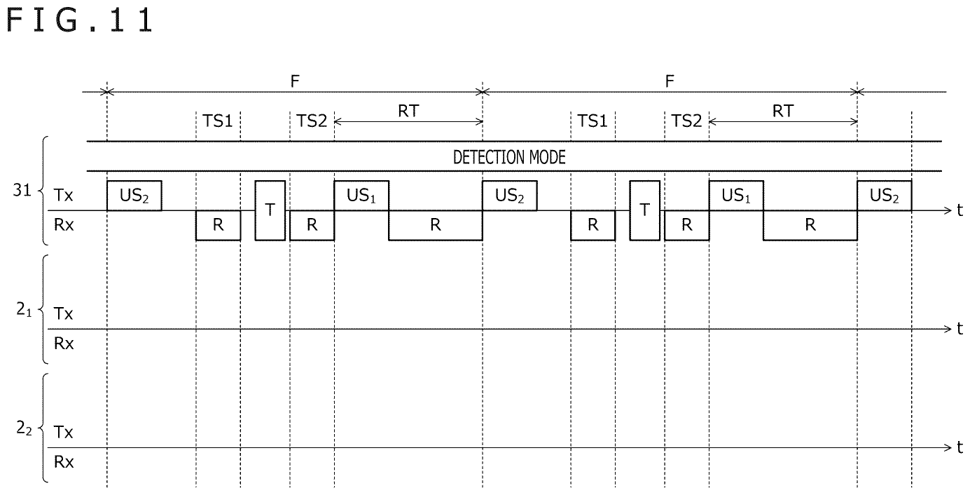

FIG. 11 is a diagram illustrating the operation mode of the sensor controller 31 and the styluses 2₁ and 2₂ and the transmission/reception timing of each signal according to the present embodiment. FIG. 11 depicts a case where both styluses 2₁ and 2₂ are not present near the panel surface 3a. As depicted, if the sensor controller 31 according to the present embodiment has entered the detection mode, reservation time RT used for the first protocol is set in the frame F set using the second protocol. Although the reservation time RT is set at the end of each frame F in the example of FIG. 11, it may be set at another time (excluding the time for transmitting the uplink signal US₂) in the frame F.

The sensor controller 31 sequentially executes the transmission of the uplink signal US₁ and the reception operation R of the downlink signal DS₁ in the reservation time RT. If the downlink signal DS₁ is received by the reception operation, the sensor controller 31 enters the first communication mode and starts communication with the stylus 2₁ or the stylus 2₂ by using the first protocol as in the example depicted in FIG. 5.

The sensor controller 31 performs the transmission of the uplink signal US₂ as usual at the beginning of each frame F, and performs the reception operation of the downlink signal DS₂ in each of the time slots TS1 and TS2 set in the frame F. The number of time slots set in the frame Fis smaller than that in FIG. 4 because the reservation time RT is provided in the frame F. That is, the sensor controller 31 is configured to perform the reception operation of the downlink signal DS₂ within the remaining time excluding the reservation time RT from the frame F. After the downlink signal DS₂ is received, the sensor controller 31 enters the second communication mode and starts communication with the stylus 2₂ by using the second protocol as in the example depicted in FIG. 6. After the communication with the stylus 2₂ by using the second protocol is started, it is not necessary for the sensor controller 31 to provide the reservation time RT in the frame F.

As described above, in the position detection system 1 according to the present embodiment, since the reservation time RT is set in the frame F indicated by the uplink signal US₂ and the sensor controller 31 is configured to transmit the uplink signal US₁ therein, the position detection system 1 according to the present embodiment can also prevent the old stylus 2₁ supporting only the first protocol from being unusable by the new position detection device 3 supporting the second protocol, while preventing a decrease in the search efficiency of the stylus 2, as in the first embodiment.

Here, according to the present embodiment, the communication with the sensor controller 31 is started by using the first protocol depending on when the stylus 2₂ approaches the panel surface 3a. However, in the case where both the stylus 2 and the sensor controller 31 support the second protocol, it is preferable to perform communication by using the second protocol instead of the first protocol. Therefore, in the present embodiment, setting information indicating either the first protocol or the second protocol may be stored, and the stylus 2₂ may be configured such that, if the uplink signal US for activating the stylus 2 by using one protocol indicated by the setting information is received, the downlink signal DS is transmitted using the one protocol. If the uplink signal US for activating the stylus 2 by using the other protocol instead of the one protocol indicated by the setting information is received, the downlink signal DS is not transmitted using the other protocol. In this way, since the protocol used for transmitting the downlink signal DS can be limited to one type, the bidirectional communication can be started using the new second protocol instead of the old first protocol.

While the preferred embodiments of the present disclosure have been described above, the present disclosure is not limited to such foregoing embodiments. Persons of skill in the art will appreciate that various modifications may be made without departing from the scope of the present disclosure.

For example, in the above-described first embodiment, an example of using the multiprotocol simultaneous activation uplink signal SMA-US is described, in which the SMA-US is constituted by adding the subsequent data configured to activate the stylus 2 by using the second protocol to the first portion configured to activate the stylus 2 by using the first protocol. However, in addition to such SMA-US, a further multiprotocol simultaneous activation uplink signal SMA-US may be used, which is constituted by adding to a first portion configured to activate the stylus 2 through a third protocol (a protocol different from either of the first and second protocols), subsequent data configured to activate the stylus 2 by using a fourth protocol (a protocol different from any of the first to third protocols). In this case, when determining whether or not the uplink signal US₁ is included in the received signal, the stylus 2 supporting any of the first to fourth protocols also determines whether or not a third uplink signal (US₃) configured to activate the stylus 2 by using the third protocol is included in the received signal. If it is determined that the uplink signal US₃ is included in the received signal, the stylus 2 supporting any of the first to fourth protocols further determines whether or not subsequent data (second subsequent data) for activating the stylus 2 by using the fourth protocol is added to the uplink signal US₃. If it is determined that the uplink signal US₃ is added, the transmission of the downlink signal DS can be performed using the fourth protocol.

In addition, in the above-described first embodiment, an example of transmitting the signal for activating the stylus 2 by using two different protocols by the multiprotocol simultaneous activation uplink signal SMA-US has been described, but a signal for activating the stylus 2 by using three or more different protocols may be transmitted. In this case, the sensor controller 31 can add a plurality of pieces of subsequent data supporting each protocol to the first portion, in the order from the older protocol.

In addition, the sensor controller 31 may transmit a signal for activating a device other than the stylus 2, such as an eraser device, a left-hand device, a smartphone, or a smartwatch, by the multiprotocol simultaneous activation uplink signal SMA-US. In this case, these devices are preferably configured to be capable of determining whether the subsequent data is added, as with the stylus 2₂ described in the first embodiment.

1. A position detection device comprising:
a detection mode wherein a multiprotocol simultaneous activation uplink signal is transmitted, which is obtained by adding, to a first portion configured to activate a stylus using a first protocol, subsequent data for activating the stylus using a second protocol different from the first protocol.

2. The position detection device according to claim 1,
wherein the detection mode is a mode that, after the multiprotocol simultaneous activation uplink signal is transmitted, waits for both a first downlink signal transmitted using the first protocol and a second downlink signal transmitted using the second protocol in a frame indicated by the multiprotocol simultaneous activation uplink signal.

3. The position detection device according to claim 2,
wherein the position detection device being operated in the detection mode determines whether a signal received in the frame indicated by the multiprotocol simultaneous activation uplink signal is the first downlink signal or the second downlink signal, after transmitting the multiprotocol simultaneous activation uplink signal.

4. The position detection device according to claim 2,
wherein, in a case where the first downlink signal is received in the detection mode, a first communication mode for periodically transmitting a first uplink signal according to the first protocol is entered, and
in a case where the second downlink signal is received in the detection mode, a second communication mode for periodically transmitting a second uplink signal according to the second protocol is entered.

5. The position detection device according to claim 4,
wherein, in a case where the first downlink signal is not received in the first communication mode and in a case where the second downlink signal is not received in the second communication mode, the mode returns to the detection mode.

6. The position detection device according to claim 1,
wherein the detection mode is a mode in which transmission of the multiprotocol simultaneous activation uplink signal and transmission of a second uplink signal according to the second protocol are performed according to a predetermined schedule.

7. A stylus comprising:
a first determination section that determines whether or not a first uplink signal configured to activate the stylus using a first protocol is included in a received signal;
a second determination section that determines whether or not first subsequent data for activating the stylus using a second protocol different from the first protocol is added to the first uplink signal, in a case where the first determination section determines that the first uplink signal is included in the received signal; and
a transmission section that transmits a downlink signal using the second protocol, in a case where the second determination section determines that the first subsequent data is added to the first uplink signal.

8. The stylus according to claim 7,
wherein, in a case where a result of the determination by the second determination section is negative, the transmission section transmits the downlink signal using the first protocol.

9. The stylus according to claim 7,
wherein the first determination section further determines whether or not a third uplink signal configured to activate the stylus using a third protocol different from any of the first protocol and the second protocol is included in the received signal,
the second determination section determines whether or not second subsequent data for activating the stylus using a fourth protocol different from any of the first protocol, the second protocol, and the third protocol is added to the third uplink signal, in a case where the first determination section determines that the third uplink signal is included in the received signal, and
the transmission section transmits the downlink signal using the fourth protocol, in a case where the second determination section determines that the second subsequent data is added to the third uplink signal.

10. The stylus according to claim 7,
wherein the transmission section starts, in a frame subsequent to a frame indicated by the received signal including the first subsequent data, the transmission of the downlink signal using the second protocol performed in a case where the second determination section determines that the first subsequent data is added to the first uplink signal.

11. The stylus according to claim 7,
wherein the stylus is configured to be operable in a detection mode in which a determination regarding a received signal is performed by the first determination section and the second determination section and in a second communication mode in which it is determined whether or not the received signal includes a second uplink signal using the second protocol, and
in a case where the detection mode has been entered, the second communication mode is entered in response to a determination by the second determination section that the first subsequent data is added to the first uplink signal.

12. The stylus according to claim 11, further comprising:
a pairing state selection section that selects whether or not to continue pairing with a position detection device in a case where the second communication mode has been entered,
wherein, in a case where cancellation of the pairing with the position detection device is selected by the pairing state selection section, the mode returns to the detection mode.

13. A position detection device configured to:
set a reservation time in a frame indicated by a second uplink signal configured to activate a stylus using a second protocol of a frame system, and
transmit, in the reservation time, a first uplink signal configured to activate the stylus using a first protocol different from the second protocol.

14. The position detection device according to claim 13,
wherein a reception operation of a first downlink signal transmitted using the first protocol is performed in the reservation time.

15. The position detection device according to claim 13,
wherein a reception operation of a second downlink signal transmitted using the second protocol is performed within remaining time excluding the reservation time from the frame.

16. A stylus comprising:
setting information indicating either one of a first protocol and a second protocol that are different from each other;
wherein, in response to receipt of an uplink signal for activating the stylus through either one of the first protocol and the second protocol indicated by the setting information, the stylus transmits a downlink signal using the one protocol, and
in response to receipt of an uplink signal for activating the stylus using the other protocol that is not the one protocol, the stylus does not transmit the downlink signal using the other protocol.

17. The stylus according to claim 16,
wherein the second protocol is of a system in which the downlink signal is transmitted using a plurality of time slots set in a frame,
wherein a sensor controller is configured to transmit a first uplink signal for activating the stylus using the first protocol, in a reservation time set in a frame indicated by transmission of a second uplink signal for activating the stylus using the second protocol, and
in a case where the second protocol is indicated by the setting information and the second uplink signal is received, the downlink signal using the second protocol is transmitted within remaining time excluding the reservation time from the frame indicated by the second uplink signal.
